(19) United States
(12) Patent Application Publication
(10) Pub. No.: US 2010/0097293 A1
(43) Pub. Date: Apr. 22, 2010

(54) Overlay Display Device

(76) Inventor: Roy P. McMahon, Indianapolis, IN (US)

Correspondence Address: BAKER BOTTS LLP, 2001 ROSS AVENUE, 6TH FLOOR, DALLAS, TX, 75201-2980, US

(21) Appl. No.: 12/579,088

(22) Filed: Oct. 14, 2009

Related U.S. Application Data
(60) Provisional application No. 61/106,054, filed on Oct. 16, 2008.

(51) Int. Cl. G09G 5/00

(52) U.S. Cl. 345/1.1

(57) ABSTRACT

The present disclosure relates to display devices and/or systems comprising a display screen configured to switch from a translucent image-display mode to a transparent see-through mode, configured adjacent a smart glass configured to switch from an opaque-mode to a transparent mode, with a cavity disposed in between. The cavity may be selectively illuminated by a light source. A display device/system may be enclosed in a bezel which may be configured to be mounted onto a surface such as an instrument panel or another display unit thereby providing an overlay display device. Electronic control units may selectively switch a display device from an image viewing-mode (i.e., display screen displays an image; smart glass is opaque; and light source is on), where the surface below is not visible to a see-through mode (i.e., display screen and smart glass are transparent; and light source is off), where the surface below is visible.

### CROSS-REFERENCE TO RELATED APPLICATIONS

This application claims the benefit of U.S. Provisional Patent Application Ser. No. 61/106,054, filed Oct. 16, 2008, the contents of which are hereby incorporated in their entirety by reference.

### TECHNICAL FIELD OF THE DISCLOSURE

The present disclosure relates, in some embodiments, to devices, systems, and/or methods relating to an overlay display. In some embodiments, an overlay display device and/or system of the disclosure may be placed over existing infrastructure (e.g., an instrument panel) and may be operable in a first mode to display images and may further be operable in a second mode to be transparent and provide visibility of the existing infrastructure over which the display device may be placed.

### BACKGROUND OF THE DISCLOSURE

A typical airplane cockpit may be configured with instruments that provide information to a pilot and may include navigation instruments such as an altimeter, an airspeed indicator, a horizontal situation indicator, an altitude indicator, Global Positioning Satellite (GPS) systems associated with satellite technology, angle of attack indicators for military aircrafts; radio communication instruments to communicate with air traffic controllers and/or other pilots/co-pilots in the air; and weather monitoring instruments. Each instrument typically has several controls and at least one display unit which may include one or more display screens such as an LCD (liquid crystal display) and lights such as LED (light emitting diode), OLED (organic light emitting diode) or others.

During flight, flight operators typically monitor a plurality of displays for vital flight information from multiple instrumentation panels as described above. Flight operators may also be required to access and/or operate various controls on one or more of the instrumentation panels.

Recently, multifunction displays (MFD) have been developed where a single display screen presents data from one or more instruments or sensors. However, designing and/or adapting MFD into aircrafts generally involves replacing existing displays and/or instruments from an aircraft's instrument panel with MFD hardware which typically includes a flat panel liquid crystal display. Mounting an MFD may require extensive man-hours or flight-hours for disassembly of existing displays and/or instruments followed by assembly and testing of an MFD.

However, it is often the case that all or most instruments must be retained, hence, there is no location for installing an MFD in the small confines of a typical cockpit. As a result, MFD panels are often mounted in front of a section of an existing instrument panel or off to the side as a stand-alone unit.

An MFD may have features such as hinges that allow the MFD to be swung out of the way to reach other instruments that are otherwise blocked from view. However, this is not a well designed solution.

Further, some of the instruments may have data that may not be compatible for display on an MFD and may therefore require their own display units. Thus, there may still be a need for more than one display unit that may need to be accessed by an operator.

### SUMMARY OF THE DISCLOSURE

Accordingly, a need has arisen for improved devices and/or methods for displaying information in an aircraft cockpit or in other applications where multiple instrumentation and/or displays are utilized.

The present disclosure relates, according to some embodiments, to devices, systems, means and/or methods for providing an overlay display unit that does not hinder with accessing and/or reading information from other instruments or displays that the overlay display unit may be placed on. A display device, display means or display system according to the present disclosure may be useful in several applications such as but not limited to aircraft (commercial, personal or military), spacecraft, submarines, military vehicles, control centers (for a variety of operations) where multiple instruments or displays may be monitored and/or controlled simultaneously.

In some embodiments, a display device or display system or display means of the disclosure may comprise 1) a display screen or display glass in a translucent mode for the display of images and/or information (e.g. a standard liquid crystal glass/display) that may be further operable to switch to a transparent mode where no images are displayed and surfaces below the display screen may be viewed; 2) a smart glass, i.e., a screen that may change form opaque to transparent and back to opaque following the application of an electric current; and 3) a cavity in between the two glasses.

In some embodiments, the cavity may be selectively illuminated by a light source. A display device in some embodiments may also include a flat reflective surface positioned behind the display glass or display screen, the flat reflective surface configured to even out illumination of an image that may be projected on the display glass. The flat reflective surface may be made of smart glass.

A smart glass may operate in two modes. In a first mode also referred to as an opaque mode or an image-viewing mode, a smart glass may be operable to be a white reflective surface operable to even out the illumination of an image on the display glass. In a first mode, looking at a display screen or display glass of the disclosure reveals images on the display screen of the display device.

In a second mode also referred to as a transparent mode or a see-through mode a smart glass may be operable to be transparent such that the smart glass surface and the display glass are both transparent. In a second mode, looking at a display screen of the display device or system of the disclosure may be similar to looking through a clear (or tinted) window since both the smart glass and the display glass pass light (i.e., are transparent). In this see-through mode, a surface below the display device may be visible.

In some embodiments, a display device may comprise a bezel that is configured to be mounted or placed on a surface, for example the surface of any existing infrastructure, such as but not limited to instruments, instrument panels and/or other display screens. For example, a display device or system of the disclosure may be mounted onto existing instruments or instrument panels in a cockpit without hindering view and/or use of the existing instruments by the device or system (while in a transparent mode). Accordingly, in some embodiments, a display device, means or system of the disclosure may be an overlay display device.

In some embodiments, a display device, means or system of the disclosure may be operable to switch from a first mode or a viewing mode in which a smart glass may be opaque and may comprise a light source illuminating the cavity, where the underlying surface is not visible to a second mode or a see-through mode or a transparent mode in which the smart glass and the display have a transparent opacity and the light source may be switched off and the underlying surface is visible.

In some embodiments a display device, means or system may comprise a multifunctional display (MFD) screen as the display screen.

Some embodiments of the disclosure may provide one or more technical advantages. For example, in one embodiment, an overlay display device or system may be operable to access information from multiple sources or instruments on a single MFD that would otherwise be provided by multiple displays from multiple instruments while in the image-viewing mode and provide access to information from other instruments, instrument panels and/or displays over which the display device may be placed while in the see-through mode.

As another example, particular embodiments provide a means for displaying and viewing additional information (e.g., from instruments or structures located at an underlying surface over which the display device may be mounted) without using additional surface area (e.g., in a cockpit).

This summary contains only a limited number of examples of various embodiments and features of the present disclosure. For a better understanding of the disclosure and its advantages, reference may be made to the description of exemplary embodiments that follows.

### BRIEF DESCRIPTION OF THE DRAWINGS

Some embodiments of the disclosure may be understood by referring, in part, to the present disclosure and the accompanying drawings, wherein:

FIG. 1 depicts a front elevational view showing one embodiment of an overlay display device, according to a specific example embodiment of the present disclosure;

FIG. 2 depicts a cross-sectional, side elevational view of the overlay display device of FIG. 1, according to a specific example embodiment of the present disclosure;

FIG. 3 depicts a cross-sectional, side elevational view of an overlay display device shown in an image-viewing mode, according to a specific example embodiment of the present disclosure; and

FIG. 4 depicts a cross-sectional, side elevational view of an overlay display device shown in a see-through mode according to a specific example embodiment of the present disclosure.

### DETAILED DESCRIPTION

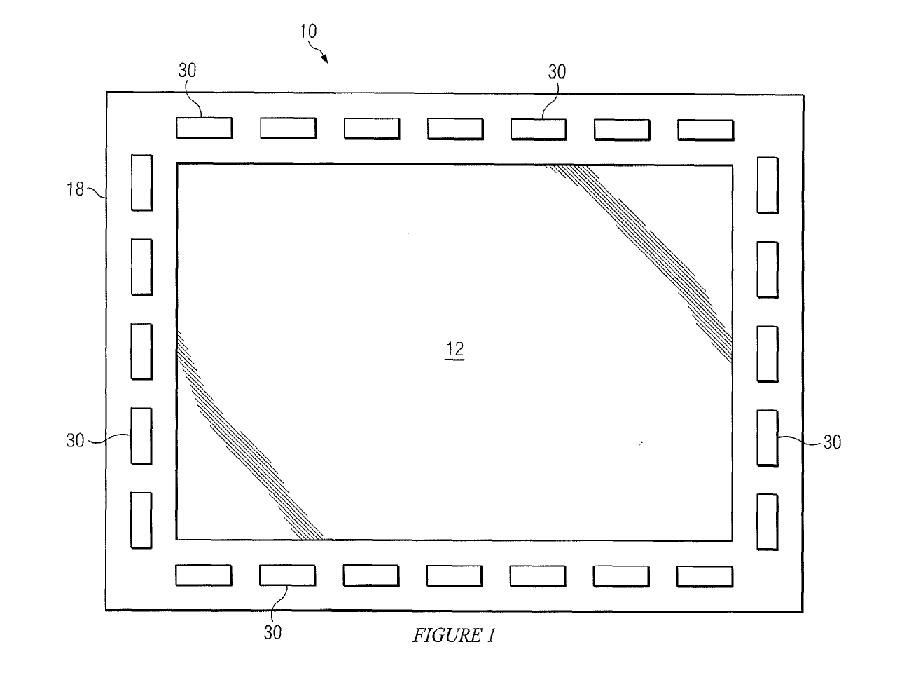

Preferred embodiments of the disclosure and its advantages may be best understood by reference to FIGS. 1-4.

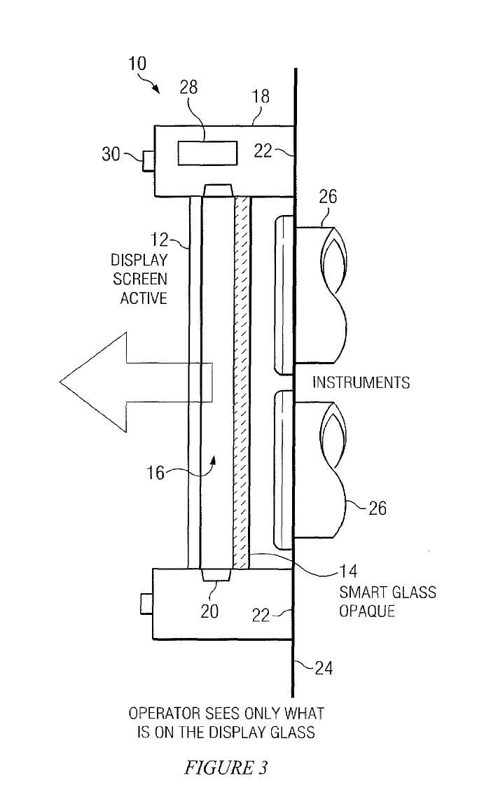

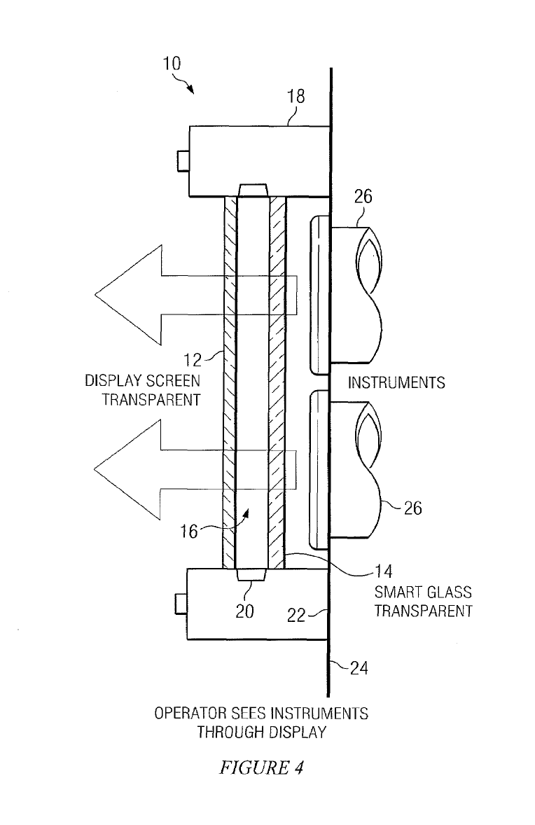

FIG. 1 depicts a frontal view of an example display device 10 and may include a display screen or display glass 12 encased in a display bezel 18. In some embodiments, display device 10 may be an overlay display device configured to be disposed on a surface (e.g., a surface of other instruments, instrument panels or display units) (depicted later in FIGS. 3 and 4).

In some embodiments, display bezel 18 may also include one or more buttons 30 operable to manipulate various devices and/or controls (e.g., electronic controls) comprised in display device 10. In other embodiments, controls operating and/or controlling components of display device 10 may be located separately for example in a separate control unit not located in a bezel (not expressly depicted).

Display screen 12 may be any suitable type of display glass material operable to display or form an image on its surface when in an image-view mode and revert to a transparent consistency when in a see-through mode. In some embodiments, while displaying an image, display screen 12 may be translucent. Display screen 12 may be a liquid crystal display (LCD) screen. LCD display screens are typically white and in a transparent mode allow substantially all light frequencies to pass through from light sources located behind the screen.

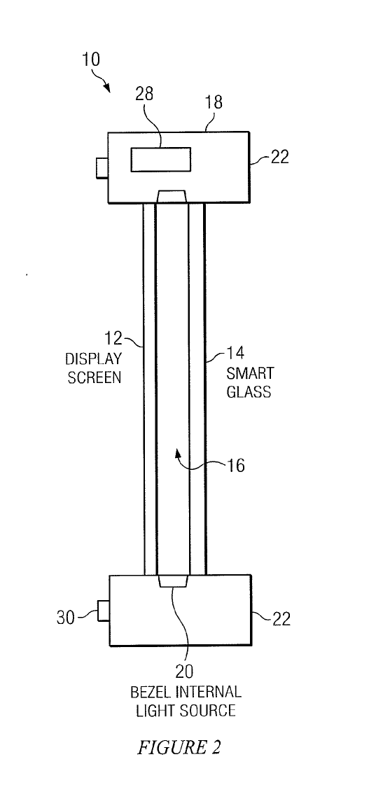

FIG. 2 depicts a cross-sectional, side elevation view of display device 10 and shows display screen or display glass 12 configured adjacent to a smart glass 14 and separated by a cavity 16. Display bezel 18 may be configured to maintain display screen 12 and smart glass 14 in a fixed physical relation to one another.

Display bezel 18 may be made of a structural rigid material, such as a metal, an alloy, plastic or a composite material and may extend around the periphery of display screen 12 and smart glass 14 (also see FIG. 1). Display bezel 18 may have a generally flat surface 22 (also see FIG. 3) configured to be disposed on a surface. Display bezel 18 may also be configured to house light source 20 such that light emanating from light source 20 may be projected into cavity 16. In one embodiment, display bezel 18 may be configured with multiple light sources 20 around its periphery. Light sources 20 may be operable to project light into cavity 16 when illuminated. Example light sources 20 may include (but are not limited to) Light Emitting Diode (LED) arrays or fluorescent tubes. In some embodiments, white fluorescent tubes may be modified for night vision capability allowing for visibility at low intensities of light.

One or more of the buttons 30 shown in FIG. 2 may be operable to switch on and off one or more light sources 20. In some embodiments, display bezel 18 may also have one or more display controller unit 28.

Smart glass 14 may be a glass configured to switch its opacity in response to an input signal from opaque (smart glass 14 may be opaque while the display device 10 is in an image viewing-mode) to transparent (smart glass 14 may be transparent while the display device 10 is in the see-through mode). An example input signal that may switch the opacity of smart glass 14 may be a relatively low DC voltage level. In one example, smart glass 14 may be controlled by display controller unit 28 (e.g., by providing an input signal) to alternatively switch between a transparent opacity while in a see-through mode to an opaque opacity while in a viewing mode.

In some embodiments, in an opaque-mode a smart glass 14 may be white or may have a generally white colored hue to allow for maximum reflection of light and to allow images on the adjacent display screen 12 to be visible. In such a mode, light originating from a light source 20 and reflected from the surface of smart glass 14 may provide relatively good dispersion of light to display screen 12 which may be translucent while in the viewing mode. In some embodiments, smart glass 14 may be comprised of a liquid crystal glass.

Selective adjustment of overlay display device 10 from the see-through mode to the viewing-mode may be controlled by one or more display controller unit 28. A display controller unit 28 may be operable to control the operation of display screen 12 as is well known in the art of LCD display screens (and other similar screens). For example, display controller unit 28 may include any suitable form of logic or circuitry that coordinates operation of display screen 12. In one embodiment, display controller 28 may include a computer processor operable to execute instructions stored in a memory.

In some embodiments, one or more display controller unit 28 may be further operable to manipulate the opacity of smart glass 14. One or more display controller unit 28 may also be operable to control the operation of light source 20. In some embodiments, separate display controller units 28 may control display screen 12 and smart glass 14. In some embodiments, one or more display controller units may be comprised in one or more control units located outside bezel 18.

In one embodiment, one or more button 30 may be coupled to one or more display controller units 28 that allow switching on or off a display controller 28 to manipulate images shown on display screen 12 (i.e., selecting the see-through mode or the viewing-mode of display screen 12).

FIG. 3 depicts an image-viewing mode of overlay display device 10. In some embodiments, display bezel 18 may have a generally flat surface 22 operable to be mounted onto a surface such as an instrument panel 24 having one or more instruments 26. In the image-viewing mode, display screen 12 may be selectively adjusted into an image-display mode. For example, a display controller unit 28 operably coupled to display screen 12 may switch display screen 12 into a viewing mode, thereby allowing display of images and/or formation of images onto display screen 12. In one example embodiment, display screen 12 may be a liquid crystal display (LCD) screen operable to form or display a raster image on its surface and becomes translucent while in the image-viewing mode (or image-display mode) under control of display controller 28.

In an image-viewing mode, a display controller unit 28 may be operably coupled to smart glass 14 to switch smart glass 14 into an opaque opacity (see FIG. 3). In an image-viewing mode as shown in FIG. 3, display screen 12 may be translucent, smart glass 14 may have an opaque opacity and light source 20 may be switched on.

In this mode, an operator (such as an airplane pilot), may see images displayed only on display screen 12 of the display device 10 and may not be able to see the instruments 26 (i.e., surface) over which the display device may be mounted.

FIG. 4 depicts a see-through or transparent mode, wherein instruments 26 (i.e., surface behind overlay display device 10) that are behind the overlay display device 10 may be viewed normally through a now transparent display screen 12 and a transparent smart glass 14. In a transparent mode, display controller 28 operably connected to display screen 12 switches display screen 12 into a transparent mode. Display controller 28 operably connected to smart glass 14 switches smart glass 14 into a transparent mode and at least one button 30 may be used to switch one or more light source 20 off. An operator may see-through the now transparent display screen 12 and the now transparent smart glass 14.

In a see-through mode, when 12 and 14 are transparent, instruments 26 located at the surface below display device 10 may be internally lit and may be viewable through the display. In some embodiments, instruments 26 may have one or more instrument light sources (not expressly depicted) which may be controlled externally by instrument light controls (not expressly depicted) that may be integrated into one or more display controller units 28 of display device 10. Simple relay circuits may be used to integrate and coordinate control of underlying instrument lighting. In some embodiments, such as with older instrument designs, additional LED array light sources may be added around an inside surface of display device 10 located behind smart glass 14 to provide adequate light for viewing instruments 26 while the display device 10 is in a transparent mode.

Display bezel 18 may be mounted on instrument panel 24 using one or more suitable type of fastening elements, including, but not limited to screws, bolts, and/or adhesives. Overlay display device 10 may be configured to have dimensions suitable for the purpose it serves. In one example embodiment, overlay display device 10 may have dimensions operable to placed over one or more instruments 26 of an instrument panel 24.

In some embodiments, a display device or system of the disclosure, may have one or more display controller units 28 located outside of the bezel (not expressly depicted). For example, a control unit, located outside the display device or display system 10, may have one or more display controller units 28 operable to control one or more embodiments such as but not limited to 1) display of the display screen from the translucent image-display mode to the transparent see-through mode; 2) opacity of the smart glass from the opaque-mode to the transparent see-through mode; and/or 3) illumination of the light source; and/or 4) illumination of underlying surface below the overlay display device 10. In such embodiments, a bezel 18 may simply function as a display bezel and encase a display screen 12 and smart glass 14. In related embodiments, bezel 18 may include light source 20 and may not include the buttons 30 and/or other controller units such as 28. A separate control unit and/or display controller units as set forth here may comprise all the electronic and other mechanical control components.

The present disclosure also describes, in some embodiments, an overlay display device 10 that may comprise a display means 12 configured to switch from a translucent image-display mode to a transparent see-through mode, an opacity changing means 14 positioned behind the display means 12, disposing a cavity 16 in between and configured to switch from an opaque light reflecting mode to a transparent light transmitting mode, as encasing means 18 that extends around the perimeter of display means 12 and opacity changing means 14 and the encasing means 18 configured to be mounted on a surface 24 or 26 such that the surface 24 or 26 is visible through the display device 10 when the display means 12 is in the transparent see-through mode and the opacity changing means 14 is in the opaque light reflecting mode and is not visible through the display device 10 when the display means 12 is in the translucent image-display mode and the opacity changing means 14 is in the transparent light transmitting mode.

Although descriptions of overlay display device, means and/or system 10 in this disclosure have been made in relation to instrument panels in aircraft, the teachings of the present disclosure may also be applied to placing an overlay display device, system and/or means 10 into other types of vehicles, such as but not limited to spacecraft, submarines, military vehicles, armored personnel carriers, tanks, surface ships, boats, automobiles and/or trucks, and in control centers such as but not limited to space-shuttle control stations, weather monitoring stations and/or satellite controlling centers. Furthermore, in some embodiments, display device 10 may be used an a screen, not expressly overlying on other instruments/infrastructure, that may be used for displaying information or images in one mode and may alternatively be switched to a window-like see-through screen in another mode.

Any application or device that may be facilitated by having a display unit (such as but not limited to an MFD) to display additional information provided by one or more instruments, sensors, data processing devices/systems, computers, or other sources of information, while also allowing alternative access to other instruments, infrastructure or displays that may be in the background may benefit from the devices of the present disclosure. In some embodiments, the devices and systems of the present disclosure provide selective display of existing infrastructure or display of information from other sources, without using additional surface area. This may be particularly advantageous in complex data-monitoring operations that require to be carried out in small confined spaces. In some embodiments, screens may be used to display information or images when required and may switch off to a window-like mode when not displaying information.

The present disclosure also provides methods for using the display devices or systems. For example, a method according to the disclosure may be operable to alternatively and/or selectively view images on an overlay display device in a first image-display mode and view instruments or display units placed under the display device in a second see-through mode and may comprise: a) viewing images in a first image-display mode by switching a first display controller unit operable to control the display of a display screen to an image-display mode; switching a second display controller unit of the overlay display device operable to control the opacity of a smart glass to an opaque mode; and optionally switching on a light source in the overlay display device disposed between the display screen and the smart glass. The method may further comprise b) alternatively viewing instruments or display units placed under the display device in a second see-through mode and may comprise: switching the first display controller unit to control the display of the display screen to a see-through mode; switching the second display controller unit to control the opacity of the smart glass to an transparent mode; and optionally switching off the light source in the overlay display device.

In some embodiments, where a display device or system of the disclosure may have a single display controller unit operable to control both the display of a display device and the opacity of a smart glass a single switching step may be performed to change the view from an image-display mode to a see-through mode. In some embodiments, a single display controller unit may be further operable to switch on or off the light source in concert with the changing view modes.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A display device comprising:
a display screen configured to switch from a translucent image-display mode to a transparent see-through mode;
a smart glass positioned behind the display screen and configured to switch from an opaque-mode to a transparent see-through mode; and
a display bezel that extends around the perimeter of the display screen and the smart glass and that is configured to be mounted on a surface such that the surface is visible through the display device when the display screen is in the transparent see-through mode and is not visible through the display device when the display screen is in the translucent image-display mode.

2. The display device of claim 1 further comprising a cavity disposed in between the display screen and the smart glass.

3. The display device of claim 2 further comprising at least one light source disposed in the display bezel, the light source operable to illuminate the cavity.

4. The display device of claim 3, wherein the display bezel further comprises at least one button operable to turn on or turn off the light source.

5. The display device of claim 1, wherein the display bezel further comprises at least one display controller unit operable to control the display of the display screen.

6. The display device of claims 5, wherein the at least one display controller unit is further operable to control the opacity of the smart glass.

7. The display device of claims 5, further comprising a plurality of display controller units wherein at least a first display controller unit is operable to control the display of the display screen and at least a second display controller unit is operable to control the opacity of the smart glass.

8. The display device of claim 7, wherein at least a third display controller unit is operable to control the illumination of the light source.

9. The display device of claim 3, further comprising:
a control unit not disposed in the bezel and operable to control:
display of the display screen from the translucent image-display mode to the transparent see-through mode;
opacity of the smart glass from the opaque-mode to the transparent see-through mode; and
illumination of the light source.

10. The display device of claim 9, wherein the control unit comprises one or more display controller units.

11. The display device of claim 1, wherein the display screen is a liquid crystal display (LCD) screen or a multifunctional display (MFD) screen.

12. The display device of claim 1, wherein the smart screen may be comprised of a liquid crystal glass.

13. A display system comprising:
a display screen configured to switch from a translucent image-display mode to a transparent see-through mode;
a smart glass positioned behind the display screed and configured to switch from an opaque-mode to a transparent see-through mode;
a cavity disposed in between the display screen and the smart glass;
a display bezel extending around the perimeter of the display screen and the smart glass; and
the display bezel configured to be mounted on a surface such that the surface is visible through the display device when the display screen is in the transparent see-through mode and is not visible through the display device when the display screen is in the translucent image-display mode.

14. The display system of claim 13, further comprising at least one light source disposed in the display bezel, the light source operable to illuminate the cavity.

15. The display system of claim 13, further comprising one or more display controller units operable to control the display of the display screen from a translucent image-display mode to a transparent see-through mode and the opacity of the smart glass from an opaque-mode to a transparent see-through mode.

16. The display system of claim 13, wherein the surface is the surface of an instrument panel.

17. An overlay display device comprising:
a display means configured to switch from a translucent image-display mode to a transparent see-through mode;
an opacity changing means positioned behind the display means disposing a cavity between the opacity changing means and the display means;
the opacity changing means configured to switch from an opaque light reflecting mode to a transparent light transmitting mode;
an encasing means that extends around the perimeter of the display means and the opacity changing means; and
the encasing means configured to be mounted on a surface such that the surface is visible through the display device when the display means is in the transparent see-through mode and the opacity changing means is in the opaque light reflecting mode and is not visible through the display device when the display means is in the translucent image-display mode and the opacity changing means is in the transparent light transmitting mode.
